(19) United States
(12) Patent Application Publication
(10) Pub. No.: US 2005/0270290 A1
(43) Pub. Date: Dec. 8, 2005

(54) FONT DISPLAY METHOD USING A FONT DISPLAY CO-PROCESSOR TO ACCELERATE FONT DISPLAY

(76) Inventors: Yu Liu, Kao-Hsiung Hsien (TW); Po-wei Huang, Hsin-Chu City (TW); Wen-Kuo Lin, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/709,938

(22) Filed: Jun. 8, 2004

(51) Int. Cl. G06T 11/00; G06F 15/16

(52) U.S. Cl. 345/467; 345/502

(57) ABSTRACT

A font display method using a font display co-processor to accelerate font display includes receiving font information from a baseband CPU and loading a mapping table, a font bitmap table, and a font code table to the font display co-processor. The font information is corresponded to a font code according to the font code table. The font code corresponds to a font index according to the mapping table. The font index is corresponded to a font bitmap according to the font bitmap table. Some special effects may be added to the font bitmap displayed on a display module.

### BACKGROUND OF INVENTION

1. Field of the Invention

The present invention relates to a font display method, and more particularly, to a font display method using a font display co-processor to accelerate font display.

2. Description of the Prior Art

E-mails and messages are popular communication media in the modern information-oriented society. We get information by reading the words on the screen of a PDA or a computer. Particularly, the styles of the displayed words evoke feelings in a reader. Thus, the fonts in an e-mail or a message, like spice in food, become important to increase communication amusement.

Conventionally, the fonts displayed on the screen of a PDA, a computer, a mobile phone, or the like are rendered directly by the baseband CPU on the font codes of each application. The application can be Man-Machine interface (MMI), Short Message Service (SMS), E-mail, and so forth. The baseband CPU has a memory to store some tables, and the font codes are transformed to bitmaps according to these tables and finally shown on the screen of a display module.

Please refer to FIG. 1, which illustrates a memory 10 of a baseband CPU having three transformation tables for font display according to the prior art. The memory 10 comprises a mapping table 12, a font bitmap table 14, and a font code table 16. The font information carrying the signals of the font to be displayed is input into the baseband CPU first. However, the display module requires a bitmap data form. Therefore, font information should be transformed to a bitmap, and the transformation procedure is performed according to three tables in the memory 10. The font code table 16 corresponds font information to a plurality of font codes, the mapping table 12 corresponds a plurality of font codes to a plurality of font indexes, and the font bitmap table 14 corresponds the font indexes to the bitmaps.

When a baseband CPU receives font information, the baseband CPU transforms the font information into a font code according to the font code table 16 first. Then the font code is corresponded to a font index according to the mapping table 12. Finally, the font index is transformed to a bitmap and the bitmap representing the original font is displayed on the screen of a display module.

However, a baseband CPU is not a powerful processor and is used mainly to perform tasks such as voice encoding and decoding, signal transmission and reception, and signal synchronization. Therefore, the font-displaying task is placed at a lower priority than those tasks. As a result, the response time of a font displaying task will be degraded when the baseband CPU is dealing with other high priority tasks. Further more, it will be even more difficult to have a font displaying fancier and advanced special effects on a mobile phone due to the limited baseband CPU computation power and the low priority assignment of font-displaying task.

### SUMMARY OF INVENTION

It is therefore an objective of the claimed invention to provide a font display method in order to solve the abovementioned problems.

According to the claimed invention, a font display method utilizes a system CPU and a font display co-processor to accelerate font display. Font information is transmitted from the system CPU to the co-processor. A mapping table and a font bitmap table are loaded into the font display co-processor. The font display co-processor corresponds the font information to a font index according to the mapping table. Next, the font display co-processor corresponds the font index to a font bitmap according to the font bitmap table. Finally, the font display co-processor transmits the font bitmap to a display module.

A device utilizing the present invention includes a system CPU for overall operations of the device and a font display co-processor to accelerate font display. The font display co-processor includes a memory, a processing unit, a receiving unit, and a transforming unit. The memory is used to store font information, a mapping table, and a font bitmap table. The processing unit electrically connects to the memory and is used to load the font information, the mapping table, and the font bitmap table to the memory. The receiving unit electrically connects to the system CPU to receive the font information from the system CPU. The transforming unit electrically connects to the memory and the receiving unit for transforming the font information into a font code, or transforming a font code into a font index, or transforming a font index to a font bitmap.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a memory of a baseband CPU having three transformation tables for font display according to the prior art.

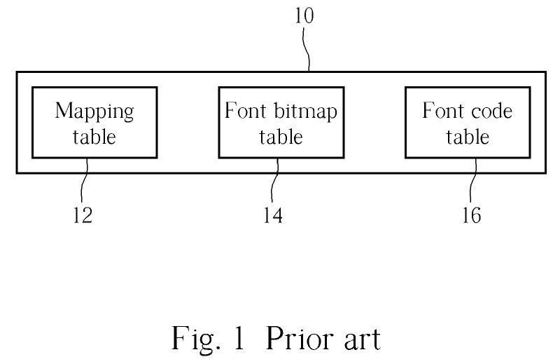

FIG. 2 illustrates a font display system according to the present invention.

FIG. 3 illustrates another font display system according to the present invention.

FIG. 4 illustrates another font display system according to the present invention.

FIG. 5 illustrates the flow chart of the font display method of FIG. 2.

FIG. 6 illustrates the flow chart of the font display method of FIG. 3.

FIG. 7 illustrates a font display co-processor according to the present invention.

### DETAILED DESCRIPTION

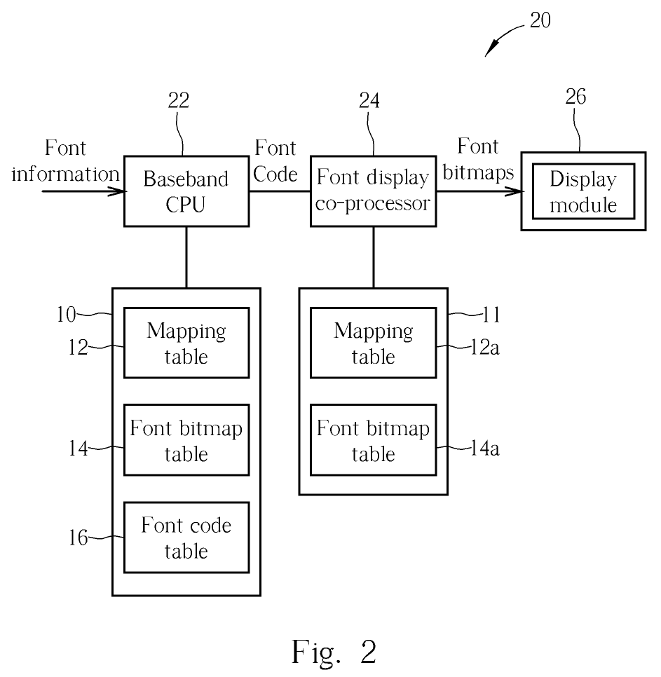

Please refer to FIG. 2 that illustrates a first embodiment of a font display system 20 according to the present invention. The font display system 20 comprises memory 10 and 11, a baseband CPU 22, a font display co-processor 24, and a display module 26. The memory 10 comprises a mapping table 12, a font bitmap table 14, and a font code table 16. The memory 11 comprises a mapping table 12a and a font bitmap table 14a. Unlike a conventional method, the present invention exploits a font display co-processor 24 cooperating with the system baseband CPU 22 to process the font information. When started up, the mapping table 12a and the font bitmap table 14a are loaded into the memory 11 from the memory 10. The baseband CPU 22 receives font information and decodes the font information into a font code according to the font code table 16 in the memory 10. Next, the font code sent to the font display co-processor is transformed to a font index according to the mapping table 12a. The font index is transformed to a bitmap according to the bitmap table 14a. Then, the co-processor to locates the bitmap of the font and then adds some special effects to the bitmap before delivering the bitmap to the display module 26. When an AP (application) requests to display text on a screen, the baseband CPU only has to prepare and send the font code, the mapping table, and the bitmap table to the font display co-processor 24. After that, the baseband CPU 22 is released from the font displaying task and can resume the other high priority tasks.

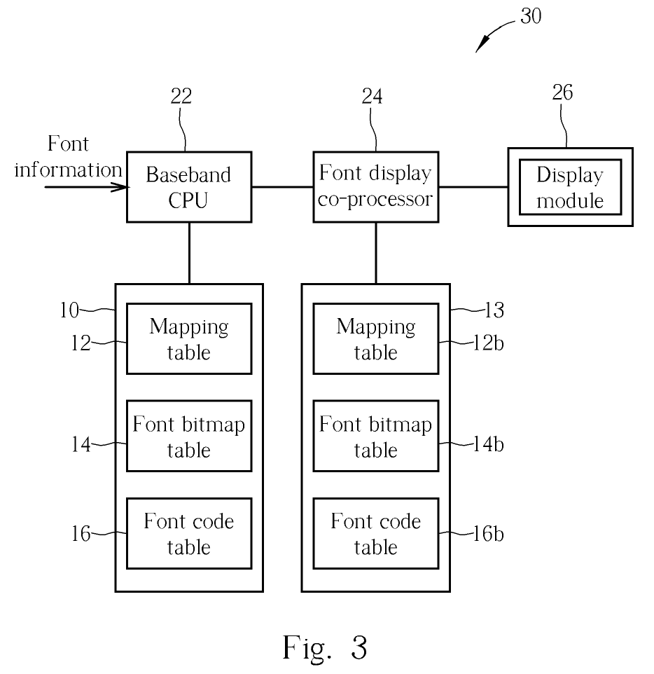

Please refer to FIG. 3. FIG. 3 illustrates a second embodiment of a font display system 30 according to the present invention. The font display system 20 comprises memory 10 and 13, a baseband system CPU 22, a font display co-processor 24, and a display module 26. The memory 10 comprises a mapping table 12, a font bitmap table 14, and a font code table 16. The memory 13 comprises a mapping table 12b, a font bitmap table 14b, and a font code table 16b. The mapping table 12, the font bitmap table 14, and the font code table 16 are maintained in the host (such as a mobile phone, a hand-held device, a PDA, a computer, etc.). These tables can be modified or replaced when it is necessary. When started up or during an AP request, the mapping table 12b, the font bitmap table 14b, and the font code table 16b are loaded into the memory 13 of the font display co-processor 24.

Since all the tables in the baseband CPU 22 have been transferred to the font display co-processor 24, when an AP requests to display text on a screen, the baseband CPU 22 directly delivers received font information to the font display co-processor 24. The font information is then transformed into a bitmap by the font display co-processor 24 according to the procedure mentioned above and finally shown on the screen of the display module 26. Notice that the font display co-processor 24 can add special effects to the bitmaps before rendering them to the display module 26. The second embodiment of the present invention not only reduces the workload of the baseband CPU 22 but also dramatically reduces the AP programming effort as the AP only needs to command the baseband CPU 22 to pass font information. It should also be noted that the double-mapping implementation for fetching font bitmaps in the present invention provides the freedom for customizing the font sets stored in the memory and for randomly accessing the bitmaps of those font sets.

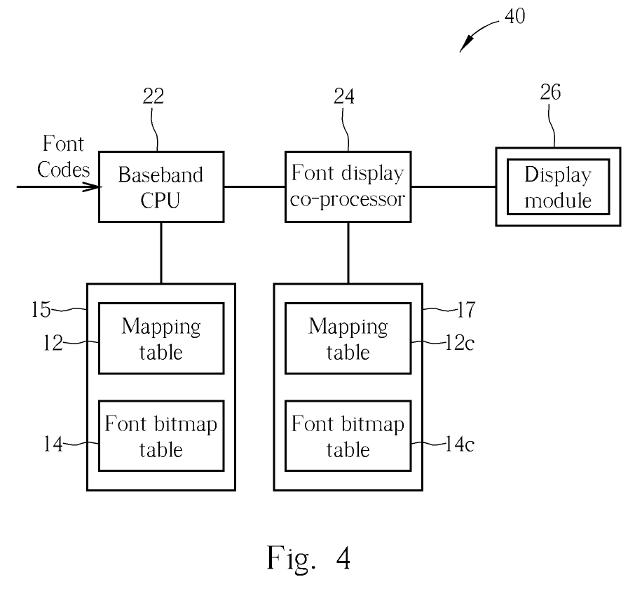

Please refer to FIG. 4, which illustrates a third embodiment of a font display system 40 according to the present invention. The font display system 40 comprises memory 15 and 17, a system baseband CPU 22, a font display co-processor 24, and a display module 26. The memory 15 comprises a mapping table 12 and a font bitmap table 14. The memory 17 comprises a mapping table 12c and a font bitmap table 14c. In this case, it is supposed that all standard font sets are stored in the memory 15 and 17 and there is no need to store the font code in the memory. Instead, the mapping table is used to store the font code. The font codes as well as the font bitmaps in the bitmap table are stored in the same order that follows the sequence of the font sets defined by the standard. Therefore, by simply decoding a font code received, the font display co-processor 24 will be able to locate the associated font bitmap from the bitmap table by directly counting the relative location of the font code in the mapping table.

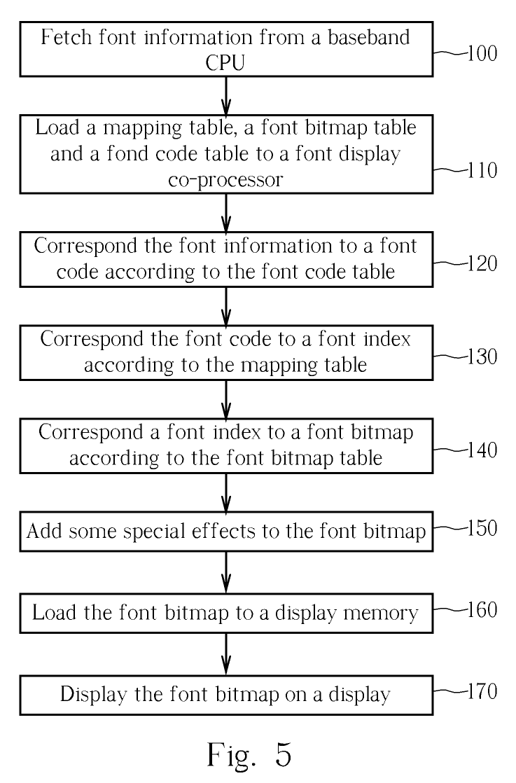

Please refer to FIG. 5 that illustrates a flow chart of the first embodiment of the font display method according to the present invention. The font display method utilizes a font display co-processor that cooperates with a baseband CPU to accelerate font display and reduce the workload of the baseband CPU. The baseband CPU is used to prepare and send the font data to the font display co-processor when an AP requests to display text on a screen. The memory of the baseband CPU stores a font code table, a mapping table, and a font bitmap table. In step 100, the font display co-processor fetches font information from a baseband CPU. In step 110, a mapping table, a font bitmap table, and a font code table are loaded to the font display co-processor. In step 120, the font information is corresponded to a font code according to the font code table. In step 130, the font code is corresponded to a font index according to the mapping table. In step 140, the font index is corresponded to a font bitmap according to the font bitmap table. In step 150, some special effects, such as colorful fonts, animation fonts, and 3D fonts, etc., may be added to the font bitmap. In step 160, the font bitmap is loaded into a display memory. In the last step 170, the font bitmap is displayed on a display.

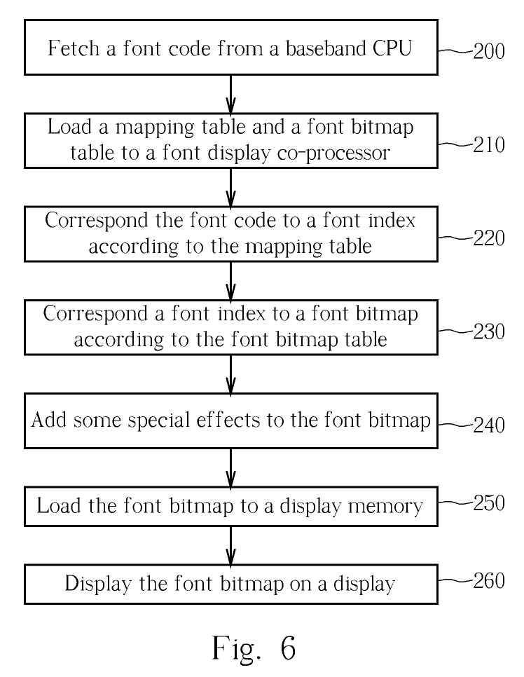

Please refer to FIG. 6, which illustrates a flow chart of the second embodiment of the font display method according to the present invention. The second embodiment of the font display method also takes advantages of a font display co-processor to accelerate font display. Moreover, in the second embodiment, all standard font sets have been stored in the memory of the baseband CPU and the font display co-processor, so there is no need to store the font code table in the memory. Therefore, the memory of the baseband CPU stores a mapping table and a font bitmap table. The mapping table is used to store the font code. The font codes as well as the font bitmaps in the font bitmap table are stored in the same order that follows a predefined sequence of the font sets. By simply decoding a font code received, the font display co-processor will be able to locate the associated font bitmap from the bitmap table by directly counting the relative location of the font code in the mapping table. The flow of the second embodiment of the font display method is described as follows:

Step 200: a font display co-processor fetches a font code from a baseband CPU.

Step 210: load a mapping table and a font bitmap table to the font display co-processor.

Step 220: correspond the font code to a font index according to the mapping table.

Step 230: correspond a font index to a font bitmap according to the font bitmap table.

Step 240: add some special effects, such as colorful fonts, animation fonts, and 3D fonts, etc., to the font bitmap.

Step 250: load the font bitmap to a display memory.

Step 260: display the font bitmap on a display.

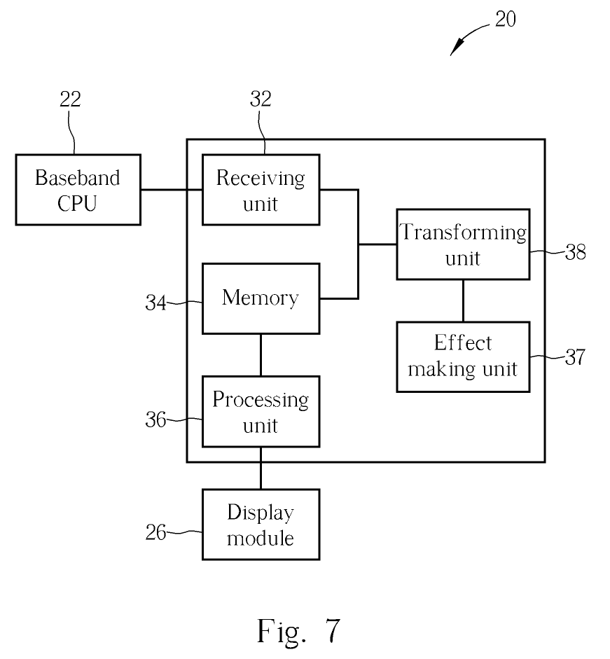

Please refer to FIG. 7. FIG. 7 illustrates a font display co-processor 50 according to the present invention. The font display co-processor 20 cooperates with a system baseband CPU 22 and connects to a display module 26. The font display co-processor 50 comprises a receiving unit 32, a memory 34, a processing unit 36, a transforming unit 38, and optionally an effect making unit 37. The memory 34 is used to store a font code table, a mapping table, and a font bitmap table. The processing unit 36 electrically connected to the memory 34 is used to load the font code table, the mapping table, and the font bitmap table to the memory 34. The receiving unit 32 is used to receive font information or font data from the baseband CPU 22. The transforming unit 38 electrically connected to the memory 34 and the receiving unit 32 transforms the font information into a font code, transforms a font code into a font index, or transforms a font index to a font bitmap. The effect making unit 37 may be used to add some special effects, such as colorful fonts, animation fonts, and 3D fonts, to the font bitmap. In summary, the receiving unit 32 is used to execute the step 100 in FIG. 5 and the step 200 in FIG. 6. The processing unit 36 and the memory 34 are used to execute the step 110 in FIG. 5 and the step 210 in FIG. 6. The transforming unit 38 and the memory 34 execute the steps 120, 130, and 140 in FIG. 5 and the steps 220 and 230 in FIG. 6. The effect making unit 37 is used to execute the step 150 in FIG. 5 and the step 240 in FIG. 6. The display module 26 implements the step 160 in FIG. 5 and the step 250 in FIG. 6.

In the prior art, the font display is implemented by using a system baseband CPU. However, the baseband CPU is not a powerful processor for font display. The response time of font displaying task will be degraded when the baseband CPU is dealing with other high priority tasks, such as voice encoding and decoding, signal transmission and reception, and signal synchronization. Furthermore, it will be even more difficult to have fancier and advanced special effects for the font display, due to the limited baseband CPU computation power and the low priority assignment of font display task.

In the present invention, a font display co-processor cooperating with a system baseband CPU and a font display method using a font display co-processor to accelerate font display are presented. The baseband CPU of the present invention functions as a system processor and is used mainly to perform tasks such as voice encoding and decoding, signal transmission and reception, and signal synchronization. Unlike the conventional method, the present invention exploits a co-processor to process font data and to output the bitmaps to the display module. This will not only reduce the workload for the system baseband CPU, but will also accelerate font display on the display module. Furthermore, the extra computational power provided by the co-processor delivers the flexibility to add fancier features to the fonts displayed, such as colorful fonts, animation fonts, 3D fonts, and so forth. Hence, the system manufacturers are able to design fancier MMI and other font displaying applications to distinguish themselves from the others using a conventional baseband CPU implementation. Therefore, the present invention has the advantages of accelerating font display and improving font effects.

Those skilled in the art will readily observe that numerous modifications and alterations of the device may be made while retaining the teachings of the invention. Accordingly, the above disclosure should be construed as limited only by the metes and bounds of the appended claims.

1. A font display method utilizing a system CPU and a font display co-processor to accelerate font display, the method comprising:
transmitting font information from the system CPU to the co-processor;
loading a mapping table and a font bitmap table into the font display co-processor;
the font display co-processor corresponding the font information to a font index according to the mapping table;
the font display co-processor corresponding the font index to a font bitmap according to the font bitmap table; and
the font display co-processor transmitting the font bitmap to a display module.

2. The font display method of claim 1 further comprising loading a font code table to the font display co-processor.

3. The font display method of claim 2 further comprising the font display co-processor corresponding the font information to a font code according to the font code table.

4. The font display method of claim 2 further comprising the font display co-processor corresponding the font code to the font index according to the mapping table.

5. The font display method of claim 1 further comprising loading the font bitmap to a memory of the display module.

6. The font display method of claim 1 wherein the font display co-processor comprises an effect making unit.

7. The font display method of claim 6 wherein the effect making unit adds predetermined special effects to the font bitmap.

8. The font display method of claim 7 wherein the added predetermined special effects are selected from a group consisting of colorful fonts, animation fonts, and 3D fonts.

9. A font display co-processor for use in a device comprising a baseband CPU, the font display co-processor comprising:
a memory used to store font information, a mapping table, and a font bitmap table;
a processing unit electrically connected to the memory used to load the font information, the mapping table, and the font bitmap table to the memory;
a receiving unit electrically connected to the system CPU to receive the font information from the system CPU; and
a transforming unit electrically connected to the memory and the receiving unit for transforming the font information into a font code, or transforming a font code into a font index, or transforming a font index to a font bitmap.

10. The font display co-processor of claim 9, wherein the processing unit is connected to a display memory and the processing unit is used to store the font bitmap in the display memory.

11. The font display co-processor of claim 9 further comprising an effect making unit used to add predetermined special effects to the font bitmap.

12. The font display co-processor of claim 11 wherein the predetermined special effects are selected from a group consisting of colorful fonts, animation fonts, and 3D fonts.

13. A computer system comprising:
a system CPU for controlling system operations;
a font display co-processor comprising:
a memory used to store a mapping table and a font bitmap table;
a processing unit electrically connected to the memory used to load font information, the mapping table, and the font bitmap table to the memory;
a receiving unit connected to the system CPU for receiving the font information from the system CPU; and
a transforming unit electrically connected to the memory and the receiving unit for transforming the font information into a font code, or transforming a font code into a font index, or transforming a font index to a font bitmap; and
a display module connected to the font display co-processor for displaying the font bitmap.

14. The computer system of claim 13 wherein the font display co-processor further comprises an effect making unit electrically connected to the transforming unit for adding predetermined special effects to the font bitmap.

15. The computer system of claim 14 wherein the predetermined special effects are selected from a group consisting of colorful fonts, animation fonts, and 3D fonts.

16. The computer system of claim 13 wherein the font information indicates which font is to be displayed on the display module.

17. The computer system of claim 13 wherein the font display co-processor will be able to locate the associated font bitmap from the bitmap table by directly counting the relative location of the font code in the mapping table.

18. The computer system of claim 13 wherein the system CPU is a baseband processor.

19. The computer system of claim 13 wherein the computer system is a mobile phone or a PDA.
